(19) United States
(12) Patent Application Publication
(10) Pub. No.: US 2005/0134896 A1
(43) Pub. Date: Jun. 23, 2005

(54) Data processing system, data processing method and apparatus, document printing system, client device, printing device, document printing method, and computer program

(75) Inventor: Hiroshi Koga, Kanagawa (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Tokyo (JP)

(21) Appl. No.: 10/990,902

(22) Filed: Nov. 16, 2004

(30) Foreign Application Priority Data
Dec. 26, 2003 (JP) 2003-434542
Dec. 4, 2003 (JP) 2003-406087

(51) Int. Cl. G06F 3/12; G06F 7/04; G06F 11/30; H04L 9/32; G06F 15/00

(52) U.S. Cl. 358/1.14; 340/5.8; 713/200; 358/1.15; 713/182

(57) ABSTRACT

In a network-based printing system having a communication network, such as the Internet or an intranet, printing control information is added to document data or image data, and the document or image data to which the printing control information is added is transmitted to a user designated by an access privilege level that is stored in a server. Printing of the transmitted data is controlled according to authentication information that is input by the user and the printing control information added to the document or image data.

### BACKGROUND OF THE INVENTION

1. Field of the Invention

The present invention relates to a data processing system, a data processing method and apparatus, a document printing system, a client device, a printing device, a document printing method, and a computer program. More specifically, the present invention relates to a data processing system having a client device and a printing device, which are connected to each other via a communication network, and relates to a data processing method and apparatus, a document printing system, a client device, a printing device, a document printing method, and a computer program.

2. Description of the Related Art

With the recent popularity of computer networks such as the Internet and intranets, a large volume of documents are being delivered and distributed. These documents have standard formats including tag and markup language formats, such as HTML (hypertext markup language), which is an open standard used on the World Wide Web, SGML (standard generalized markup language), XML (extensible markup language), MHEG (multimedia and hypermedia information coding experts group), and XHTML (extensible hypertext markup language).

Most documents having such standard document formats are distributed to and accessible by the general public. Generally, these documents can be freely printed (see Japanese Patent Laid-Open No. 2000-010753).

A desired document can be delivered to, accessed, and printed by any user. However, when a confidential sensitive document authorized by a qualified person is delivered to a designated user and the user is to access and print the document, the following problems occur:

(1) When a large number of sensitive documents are distributed, it is difficult to print and distribute only an important or abstract portion of the documents.

(2) In printing an authorized document, it is difficult to output (print) a signature or an image (e.g., seal) indicating authorization of the document.

(3) It is difficult to prohibit distribution, secondary distribution, and storage of paper printouts of the document although all documents are accessible on a computer display.

(4) It is difficult to allow only a user having a particular access privilege to print the document.

(5) It is difficult to prohibit or approve printing of the entire document, a portion of the document, a sensitive page, block, paragraph, sentence, word, image, text, or table, an object linked to such a document page, or a program executing object described in a programming language, such as Java, depending upon the authentication level for a predetermined access privilege.

### SUMMARY OF THE INVENTION

The present invention has been made in view of the foregoing problems. It is an aspect of the present invention to grant permission to print, in printing a general document or an authorized document, only an important or abstract portion of the document according to the access privilege level of a user who desires to view a printout of the document (hereinafter referred to as a “printout-viewing user”), such as the security level, the workplace, the office position, and the purpose, and to print the granted document, thereby achieving high printing efficiency and low printing cost.

Another aspect of the present invention is to perform printing control, in printing a confidential sensitive document, to specify permission to print the entire document, a portion of the document, a sensitive page, block, paragraph, sentence, word, image, text, or table, an object linked to such a document page, or a program executing object described in a programming language, such as Java, according to the authentication level for each access privilege of a printout-viewing user, such as the security level, the workplace, the office position, and the purpose, and to print the document.

In one aspect, the present invention provides a network-based printing system having a communication network, such as the Internet or an intranet. In this system, printing control information is added to document data or image data, where the document or image data to which the printing control information is added is transmitted to a user designated by an access privilege level that is stored in a server, and printing of the data transmitted in the transmitting step is controlled according to authentication information that is input by the user and the printing control information added to the document or image data.

In another aspect, the present invention provides a document printing method for a document printing system including a client device and a printing device, which are connected to each other via a communication network. The method includes an adding step of adding printing control information to document data and transmitting the document data, the printing control information including limitation information that limits printing of a document and instruction information that instructs printing of a predetermined image, the adding step being performed by the client device, and a printing step of, based on the document data and the printing control information transmitted in the adding step, printing the document data according to the limitation information and printing the predetermined image, the printing step being performed by the printing device.

According to the present invention, therefore, in a document printing system, printing control is performed on an entire document, a portion of the document, and each program executing object according to the security level of a printout-viewing user. Therefore, in printing a general document or a confidential document, a user is permitted to partially print the document or is prohibited from printing the document according to the access level of the user, which leads to high printing efficiency.

According to the present invention, in a document printing system having a client device and a printing device, which are connected via a communication network, the client device adds printing control information that includes limitation information that limits printing of a document and instruction information that instructs printing of a predetermined image to document data, and transmits the document data to which the printing control information is added. Based on the transmitted document data and printing control information, the printing device prints the document data according to the limitation information, and prints the predetermined image. Thus, a signature and any image indicating authorization of the document can be output. Moreover, the printing, distribution, and storage of an authorized document can be allowed or prohibited depending upon the communicating party.

The present invention intends to provide new functions. Further features and advantages of the present invention will become apparent from the following description of the embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of a basic system according to the present invention.

FIG. 2 is a block diagram of a system for creating, distributing, and printing a document.

FIG. 3 is an illustration of an HTML document including tag descriptions of access authentication control information and printing control information.

FIG. 4 is an illustration of a printer control command generated by the printing control of a printer driver based on extension tag descriptions in the HTML document.

FIGS. 5A and 5B are illustrations of documents that are printed according to authentication control information and printing control information added to document data.

FIG. 6 is a flowchart showing a series of processes for creating and editing a document, inputting authentication level information, storing the document, and distributing the document, which is performed by executing a document creating and printing application program.

FIG. 7 is a flowchart showing the details of an authentication level information inputting process module in step S606 shown in FIG. 6.

FIG. 8 is a block diagram of a host computer system constituting each of a printing server and clients, and a printer.

FIG. 9 is a flowchart showing a printing control process of a printer driver on a server and clients.

FIG. 10 is a flowchart showing the details of a decoding and authenticating process module in step S903 shown in FIG. 9.

FIG. 11 is a flowchart showing a control process performed by a printer.

FIG. 12 is a flowchart showing an input-extension-printing-control-information decoding and authenticating process module in step S1102 shown in FIG. 11.

FIGS. 13A and 13B are diagrams showing data stored in an authentication information database.

FIG. 14 is an illustration of an HTML document including tag descriptions of signature-image output control information and printing control information.

FIG. 15 is an illustration of a printer control command generated by the printing control of the printer driver based on the extension tag description in the HTML document.

FIGS. 16A and 16B are illustrations of signature and seal images printed based on designation information and printing control information of the document data.

FIG. 17 is a flowchart showing a series of processes for creating and editing a document, specifying a signature image, storing the document, and distributing the document, which is performed by executing a document creating and printing application program.

FIG. 18 is a flowchart showing the details of an authentication level information inputting process module in step S1507 shown in FIG. 17.

FIG. 19 is a flowchart showing the details of the decoding and authenticating process module in step S903 shown in FIG. 9.

### DESCRIPTION OF THE EMBODIMENTS

Embodiments of the present invention will be described in detail with reference to the accompanying drawings.

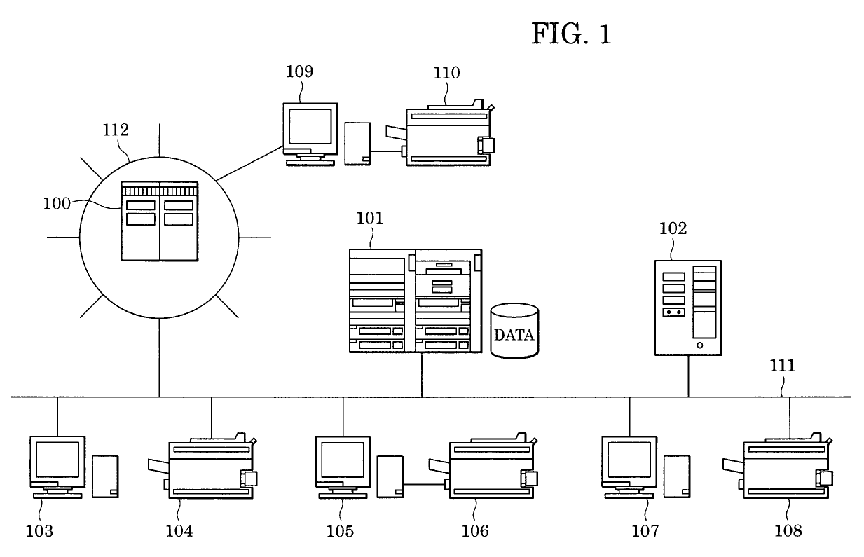

FIG. 1 is a block diagram showing the basic system configuration of a system according to an embodiment of the present invention. The system includes a Web server 100, a print server 102, a server 101, client terminal devices (hereinafter referred to as “clients”) 103, 105, 107, and 109, and printers 104, 106, 108, and 110, which are connected to communication networks, such as the Internet 112 and an intranet, e.g., a local area network (LAN) 111.

The Web server 100 is a host computer system, and serves as a provider at the core of the Internet 112. The Web server 100 is connected to the LAN 111.

The general-purpose server 101 is a host computer system connected to the LAN 111, and includes a document database for storing and managing documents and an authentication information database for storing and managing authentication information. The authentication information database stores and manages document access authentication information (access privilege level information) and user authentication information (e.g., an identifier, a user ID, a password, a group ID, etc.).

The print server 102 is a host computer system connected to the LAN 111, and controls printing operations.

The clients 103, 105, and 107 are computer systems connected to the LAN 111, and execute a document creating and printing application program.

The printers 104 and 108 are directly connected to the LAN 111.

The printer 106 and the printer 110 are connected to the client 105 and the client 109 respectively via an interface such as a Centronics, USB (universal serial bus), or serial interface.

The printers 104, 106, 108, and 110 receive and interpret a data stream that is generated in a structured document format, e.g., HTML, and perform printing control on the HTML data stream to print a document. The printers 104, 106, 108, and 110 may receive and interpret an XML, XHTML, SGML, or MHEG data stream, or a data stream described with a dedicated printing control command, and may perform printing control on the data stream to print a document.

The print server 102 or the client 105 or 109 initiate a printer driver to perform printing control, and cause the printer 104 or 108 to print a document when the print server 102 initiates the printer driver and the printer 106 or 110 to print a document when the client 105 or 109 initiates the printer driver.

In such a network communication system, one of the clients 103, 105, 107, and 109 executes a document creating and printing application program to create and edit a document, and an HTML document is generated.

By executing the document creating and printing application program, printing control information for the printing control is described with an extension tag or markup.

In the document creating and printing application program, for example, image modification printing, such as color or monochrome printing, mask processing, high or low resolution printing, or mosaic or blur processing, is specified and printing or non-printing is selected for the whole document or a region of the generated document, such as a page, a block, a paragraph, a sentence, or a word. The printing control information for the specified printing control is described with an extension tag or markup.

Each region may be designated by an image, text, a table, a document page link, and a program executing modules described with a programming language, such as Java.

The printing control information may be information for output instruction and output control of a signature or seal image indicating that the document is an authorized document, which is defined by a person having designing, creating, and editing privileges (i.e., an access privilege) of the document according to the access privilege level of a printout-viewing user. The access privilege level is an access level associated with each printout-viewing user, and indicates that, e.g., a printout of the document is fully or partially viewable.

The extension tag or markup description of the output instruction and output control information is encrypted.

The access privilege level is allocated not only to printout-viewing users but also to the document designer, author, and editor. The access privilege of the document is classified based on the security level, the workplace, the office position, the purpose, etc., and each access privilege level indicates to what extent and by what amount the document may be designed, created, edited, and accessed.

Using the document creating and printing application program, according to the access privilege level of a printout-viewing user, the document designer, author, and editor who have access privileges to design, create, and edit the document add printing control information for each access privilege level of the printout-viewing user to the document format. Certain printing control information is selected, and the selected printing control information and the access privilege information are described with extension tags or markup. The extension tag or markup descriptions are encrypted and added.

The authentication information database of the server 101 stores document access authentication information. The document access authentication information includes information indicating the access privilege level for a desired document, which is allocated to each user (e.g., document designer, author, or editor or printout-viewing user), and provides the access level for each user, e.g., to what extent and by what amount the document may be designed, created, edited, and accessed.

The authentication information database of the server 101 also stores user authentication information. The user authentication information is unique to each user (e.g., document designer, author, or editor, or printout-viewing user), and includes an identifier, a user ID, a password, and a group ID for identifying the user.

The user authentication information may further include image data indicating a signature or seal of each qualified authorizer. Based on the image data, a signature image or a seal image is printed on a document, and this document is recognized as a document authorized by the corresponding authorizer. The qualified authorizer may be the document designer, author, or editor, or an authorized third party.

By executing the document creating and printing application program, based on the information stored in the authentication information database, a document including printing control information indicating printing control for each region or object or printing control information indicating a signature or seal image is delivered to a designated printout-viewing user who is allowed to view the document via a communication network, such as the Internet or an intranet. In this case, a document uploaded to the Web server 100 may be delivered, a document may be transmitted as an attached file via e-mail, or a document stored in the server 101 via the LAN 111 may be delivered. The document may be delivered to undesignated printout-viewing users.

When the document uploaded to the Web server 100 is delivered, the document is downloaded in a file form from the Web server 100 to a storage device of a printout-viewing client (e.g., the client 109) via a communication network, such as the Internet or an intranet.

The client 109 executes the document creating and printing application program, and reads the user authentication information. The user authentication information is input when the document is generated or before the document is delivered, and includes the user ID, the password, and the group ID for each access authentication level of the printout-viewing user for the document, such as the security level, the workplace, the office position, and the purpose. The read user authentication information is checked against the user authentication information stored in the authentication information database to authenticate this client. When the client 109 is authenticated, the printer driver operated by the client 109 is instructed to print the document. The printer driver causes the printer 110 connected to the client 109 to print the desired document based on the document access level included in the printing control information.

When the document is transmitted as an attached file via e-mail to a client (e.g., the client 109) over a communication network, such as the Internet or an intranet, the document is also printed from the printer 110.

When the document stored in the server 101 via the LAN 111 is delivered, the document is stored in a storage device of the client 103, 105, or 107 used by a printout-viewing user from the server 101. The client 103, 105, or 107 executes the document creating and printing program, and reads the user authentication information that is input when the document is generated or before the document is delivered, such as the user ID, the password, and the group ID of the printout-viewing user. The read user authentication information is checked against the user authentication information stored in the authentication information database to authenticate the user. When the printout-viewing user is authenticated, the corresponding printer driver is instructed to print the document. Specifically, if the document is stored in the client 103 or 107, the printer driver operated by the printing server 102 is instructed to print the document, and the printer 104 or 108 prints the document. If the document is stored in the client 105, the printer driver operated by the client 105 is instructed to print the document, and the printer 106 prints the document.

Each printer driver drives the printer 104 or 108 or the printer 106 to print a document that is subjected to printing control for each region or object, or a document including a signature or seal image indicating an authorized document depending upon the document access level included in the printing control information. The printed document is then viewed by the printout-viewing user.

The document designer, author, and editor are allocated access levels for the access privileges to design a document, create a new document, edit a document, and distribute a document, and are allowed to add, change, or edit a document according to the access levels before or after the document is distributed.

In response to an instruction to print a document by executing the document creating and printing application program, the printer driver operated by the printing server 102 and the clients 105 and 109 converts output data generated from the document into a printer control command via an operating system, which is an operating environment of the computer system constituting each of the printing server 102 and the clients 105 and 109, and generates a print data format. The generated print data format is transmitted to the printer 104, 106, 108, or 110.

The printer driver may directly transmit HTML data to a printer if this printer is capable of interpreting and printing HTML document data.

The printer driver decodes the encrypted printing control information indicating printing or non-printing for each region or object, or the encrypted printing control information about a signature or seal image according to the access privilege authentication level of the printout-viewing user. The decoded information and the document data are transmitted to a printer.

The printers 104, 106, 108, and 110 perform printing control on the print data format or HTML data format transmitted from the printer driver, and print a document.

The printers 104, 106, 108, and 110 may receive directly or via the printer driver an HTML document format and an extended document format in which printing control information is described with an extension tag or markup, and may interpret these document formats to print a document.

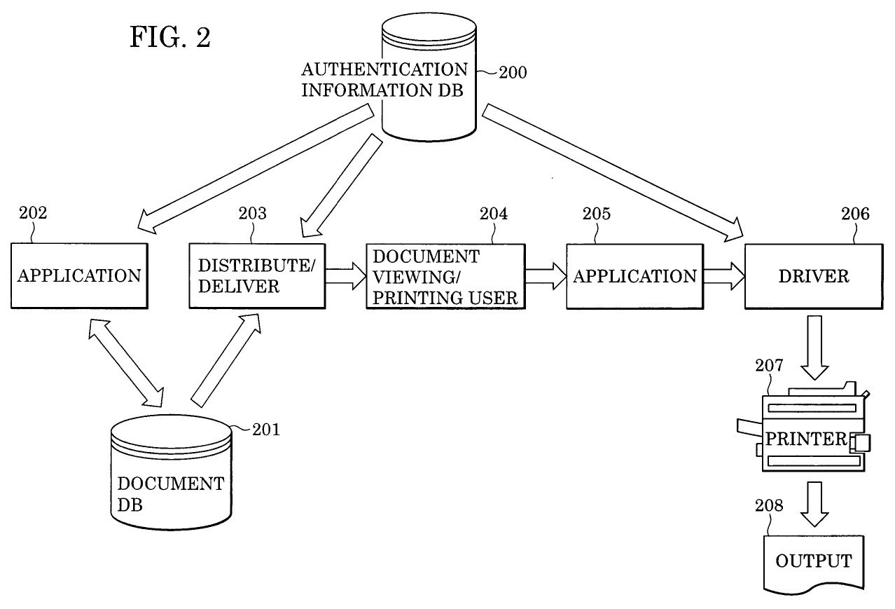

FIG. 2 is a block diagram of a system for creating, distributing, and printing a document. This system is implemented using a document creating and printing application program and a printer driver.

A document creating and printing application program 202 is executed by the client 103, 105, 107, or 109 to create and edit a document, and an HTML document is generated.

When the document designer or author specifies color or monochrome printing, mask processing, high or low resolution printing, mosaic or blur processing, and printing or non-printing for the whole document or a region of the document, such as a page, a block, a paragraph, a sentence, or a word, information (printing control information) for the specified printing control is added to the document using an extension tag or markup description.

When the document designer, author, or editor specifies a signature or seal image of the document, information (printing control information) for the specified printing control is added to the document using an extension tag or markup description.

Thus, the document designer, author, or editor generates printing control information that specifies the access level of a printout-viewing user for the document, and the printing control information is described with an extension tag or markup. The extension tag or markup description is encrypted and added to the document.

An authentication information database 200 resides on a storage device (not shown) of the server 101. The authentication information database 200 stores document access authentication information, including access privilege level information and user authentication information that identifies a document designer, author, and editor, and a printout-viewing user, such as an identifier, a user ID, a password, and a group ID.

A document database 201 resides on a storage device (not shown) of the server 101, and stores a document. The document stored in the document database 201 is delivered (203) to a printout-viewing user designated by the access privilege level stored in the authentication information database 200 via a communication network, such as the Internet or an intranet, according to an instruction from the client 103, 105, or 107 or an external device. In this case, a document that is read from the document database 201 and that is uploaded to the Web server 100 may be delivered, a document may be transmitted as an attached file via e-mail, or a document stored in the server 101 via the LAN 111 may be delivered.

The delivered document is obtained by a client used by a document accessing and printing user 204 by downloading it from the Web server 100, receiving it via e-mail, or reading it from the server 101.

The client executes a document creating and printing application program 205, and the information for document accessing, i.e., a user ID, a password, and a group ID, is input to the client from the document viewing and printing user 204. The input information is checked against the user authentication information stored in the authentication information database 200 to authenticate the user. When the document viewing and printing user 204 is authenticated, the client sends a document printing instruction to a printer driver 206.

The printer driver 206 is operated by the printing server 102 or the client 105 or 109. According to the user authentication information stored in the authentication information database 200, the printer driver 206 performs printing control to fully or partially print the document, or performs printing control to output a signature or seal image indicating an authorized document. The printer driver 206 generates output data, and converts the generated data into a printer control command to generate a print data format. The generated print data format is transmitted to a printer 207, and causes the printer 207 to output a document (208).

If the printer 207 is capable of interpreting HTML document data and printing a document, the printer 207 directly receives the HTML data, and outputs a document (208).

### First Embodiment

In a first embodiment of the present invention, a document including printing control information indicating printing or non-printing for each region or object is delivered to a client that is allowed to access the document. When the client instructs printing, the document is printed based on the printing control information.

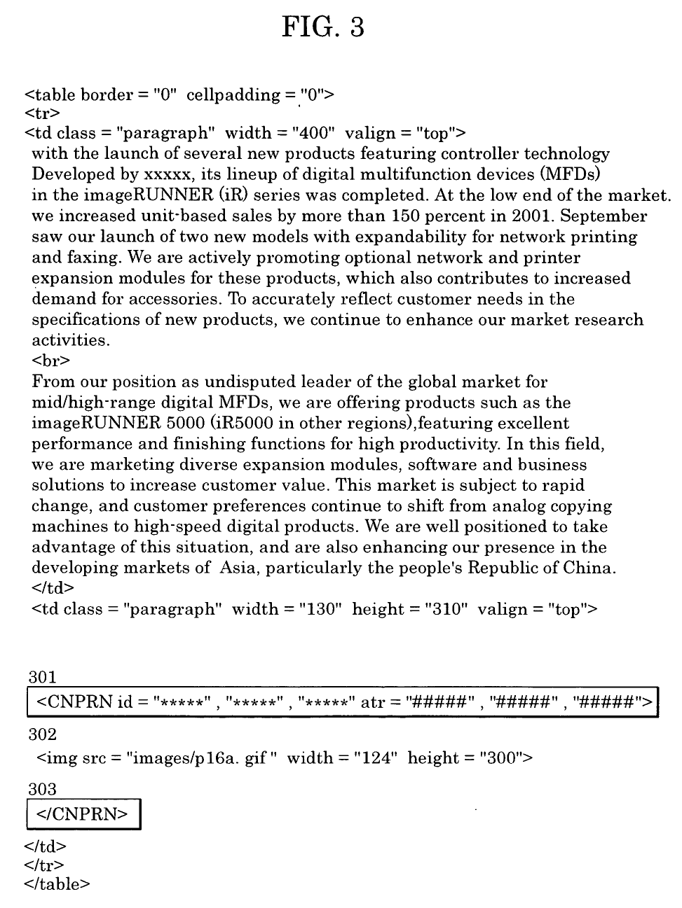

FIG. 3 shows an HTML document including tag descriptions 301, 302, and 303 of access authentication control information and printing control information.

The tag descriptions 301, 302, and 303 are extension document-printing tag descriptions in an HTML document format generated by the document creating and editing application program.

In the tag description 301, information indicating a user ID, a password, and a group ID for each access authentication level for document printing, such as the security level, the workplace, the office position, and the purpose, is specified by an “id” parameter. Attribute information indicating the control and operation subsequent to the tag description 301 is specified by an “atr” parameter. The tag description 301 is encrypted and hidden.

The tag description 302 is an extended description indicating that an image is placed in a region of the specified width and height of the printed document.

The tag description 303 indicates the end of the tag description 301.

The user ID and password specified by the “id” parameter of the extension tag 301 are checked against the user authentication information to perform authentication. The attribute information for the exclusive control specified by the “atr” parameter indicates that the subsequently described control and operation are performed if the authentication information of the user ID and password specified by the “id” parameter is mismatched. That is, the extension tag 302 between the extension tag 301 and the end extension tag 303 indicates that a “p16a.gif” image is drawn in a region of 124 pixels in width and 300 pixels in height of a printed document.

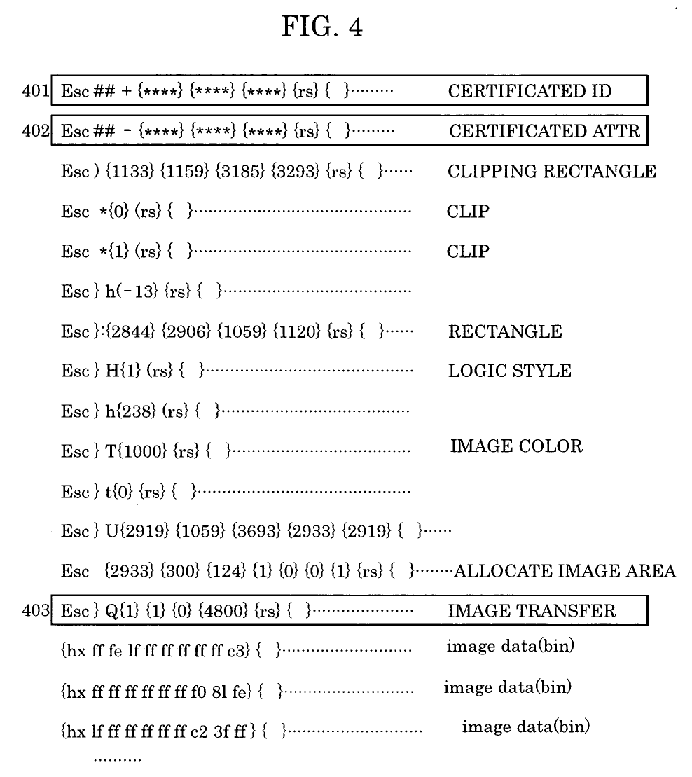

FIG. 4 shows a printer control command generated by the printing control of the printer driver based on the extension tags 301, 302, and 303 in the HTML document.

Data 401 is a command parameter including authentication information of a signer, such as a user ID, a password, and a group ID. The ID information portion is encrypted and hidden.

Data 402 is a command parameter including attribute information indicating the printing format of the signer designated by the data 401. The attribute information portion is encrypted and hidden.

Data 403 is a command parameter for printing a designated image over a region of the specified width and height at the specified printing position.

The printer control command specifies, for example, how a sensitive region of a document is to be printed according to the access authentication level. In the present embodiment, a command parameter indicating that the region is masked with a hatched rectangular portion specified by a GIF image file is transmitted to a printer to print the document.

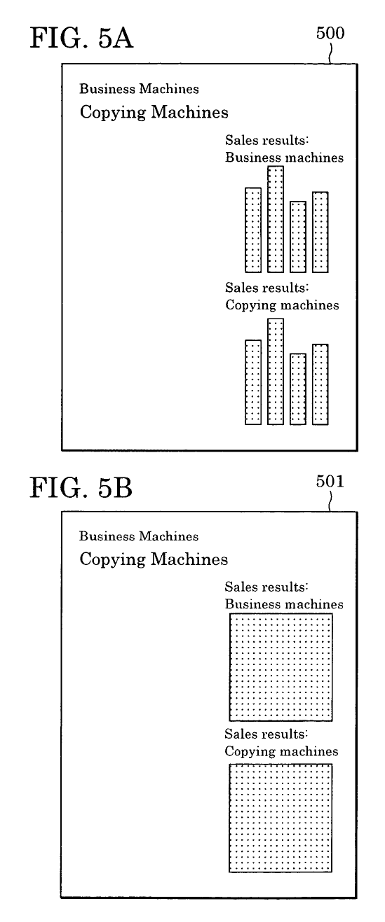

FIGS. 5A and 5B show documents 500 and 501 that are printed according to authentication control information and printing control information added to document data.

The printed document 500 shown in FIG. 5A is provided for a printout-viewing user who is allowed to perform full printing of the document, and the user can view the whole printout of the document.

The printed document 501 shown in FIG. 5B is provided for a printout-viewing user who is allowed to partially view a printout.

For example, viewing of graphs entitled “Sales results: Business machines” and “Sales results: Copying machines” in the document 501 is limited because of sensitive information, thus the graph portions are covered with a specified GIF image, in this example, a hatched rectangular image. As such, the printout-viewing user cannot view these regions in the printout.

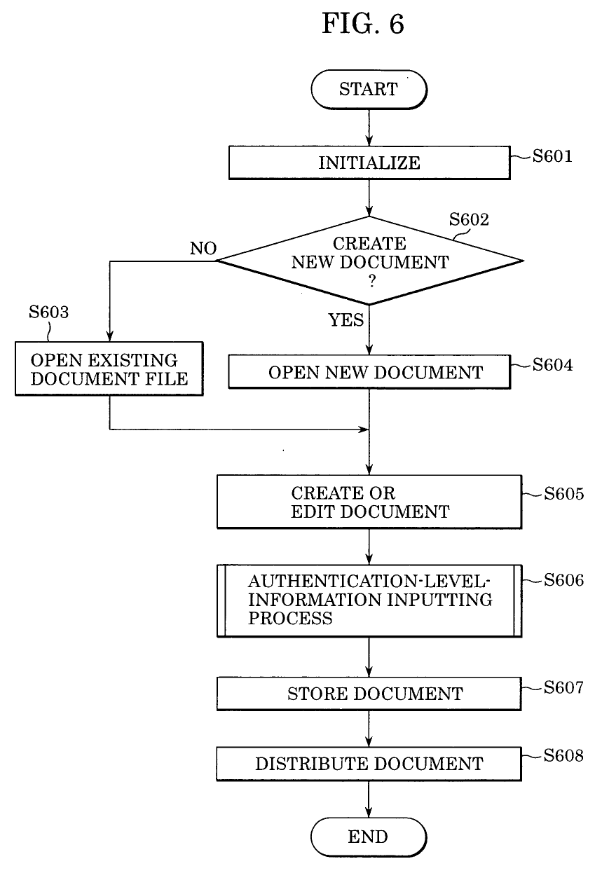

FIG. 6 is a flowchart showing a series of processes for creating and editing a document, inputting authentication level information, storing the document, and distributing the document, which is performed by executing the document creating and printing application program.

First, in step S601, the program is initiated, and attribute values are initialized.

Next, in step S602, the user selects to create a new document or to edit an existing document. The data to be created or edited may be image data.

If in step S602, the user selects to edit an existing document, flow proceeds to step S603, where the user opens an existing document file. If, however, in step S602, the user selects to create a new document, flow proceeds to step S604, where the user opens a new document.

In editing an existing document, permission, prohibition, or limited editing is granted according to the access privilege authentication level of the editor for the document, which is described with an extension tag in the document format data of the existing document.

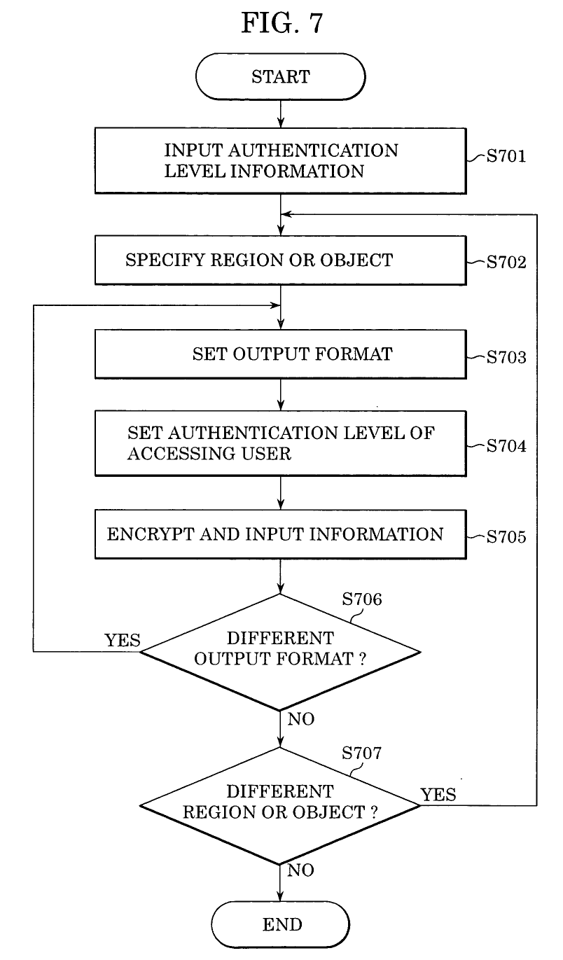

In step S605, the new document is created or the existing document is edited. Then, in step S606, an authentication level information inputting process module is executed. In this module, authentication information based on the access privilege level of the printout-viewing user, and printing control information that defines the output format for providing limited viewing of the specified object or region in the document format are described with extension tags or markup, and the extension tag or markup descriptions are encrypted and input. The details of the processing of step S606 are described below with reference to FIG. 7.

In step S607, the document generated in step S606 is stored in the document database.

Finally, in step S608, distribution of the document is instructed, and the stored document is distributed.

A document including both the authentication information and the printing control information, or a document including only the printing control information may be distributed.

FIG. 7 is a flowchart showing the authentication level information inputting process module in step S606 shown in FIG. 6.

In step S701, authentication level information based on the access privilege of the printout-viewing user is input. The printout-viewing user is a user to whom the document is to be delivered. The authentication level information is obtained from the authentication information database based on the user designated in the application program.

Next, in step S702, in a document creating or editing operation, a drawing region or object that the user is not allowed to view in the printed document is specified according to the access privilege of the printout-viewing user.

Flow then proceeds to step S703, where the output format of the specified drawing region or object, such as color or monochrome printing, mask printing, high- or low-resolution printing, mosaic or blur printing, and printing or non-printing, is set.

In step S704, the output format, such as color or monochrome printing, mask printing, high or low resolution printing, mosaic or blur printing, and printing or non-printing, is determined according to the access privilege of each printout-viewing user. Then, the authentication level for the output format of the specified drawing region or object is determined for each printout-viewing user.

In step S705, the printing control information that defines the output format of the specified drawing region or object, and authentication information of each printout-viewing user, such as a user ID, a password, and a group ID, are encrypted and input.

In step S706, a determination is made whether another output format of the specified drawing region or object is set according to the access privilege of the printout-viewing user. If another output format is set, the process returns to step S703.

If, however, another output format is not set, then flow proceeds to step S707, it is determined whether another drawing region or object is specified. If another drawing region or object is specified, the process returns to step S702. If another drawing region or object is not specified, the process ends.

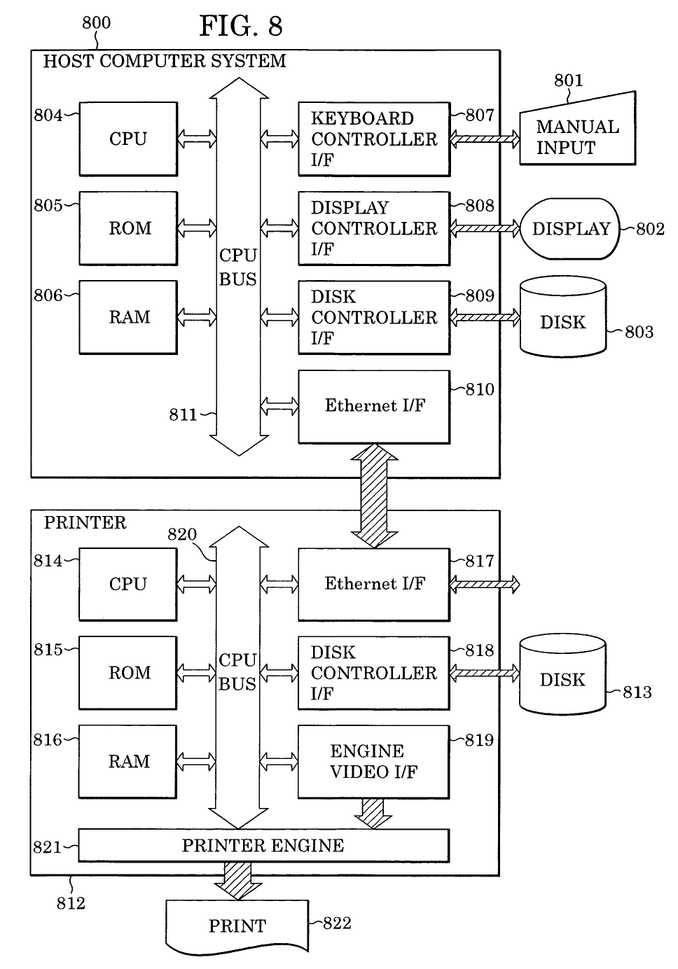

FIG. 8 is a block diagram of a host computer system 800 constituting each of the printing server 102 and the clients 103, 105, 107, and 109, and a printer 812 constituting each of the printers 104, 106, 108, and 110.

The document creating and printing application program and printer driver on the host computer system 800 perform the series of printing control operations, and the printer 812 outputs a document.

The host computer system 800 is connected to an input device 801 for inputting data, including but not limited to a keyboard and a pointing device. In addition, host compute system 800 is also connected to a display device 802 for displaying the data, and a disk 803 for storing files. A connection interface between the host computer system 800 and the printer 812 may be an Ethernet® interface when the printer 812 is the printer 104 or 108, and a Centronics, USB, or serial interface when the printer 812 is the printer 106 or 110. The connection interfaces of the present invention are not limited to the above listed interfaces, and any interface that would enable practice of the present invention is applicable.

A central processing unit (CPU) 804 of the host computer system 800 controls the host computer system 800 and the connected input and output devices 801 and 802, and executes a series of operations, such as output control, and various programs according to an input instruction. A read-only memory (ROM) 805 stores various basic programs, such as an operating system, for operating the CPU 804. A random access memory (RAM) 806 stores the document creating and printing application program and the printer driver executed by the CPU 804, and is used as a work area of the CPU 804.

A keyboard controller interface (I/F) 807 interfaces with the input device 801 connected to the host computer system 800. A display controller I/F 808 interfaces with the display 802 to enable data to be displayed on the display 802. A disk controller I/F 809 has an input and output interface with the disk 803.

An Ethernet® I/F 810 is an interface having a communication protocol for performing communication between the host computer system 800 and the printer 812. The host computer system 800 and the printer 812 may be connected by a local connection having a Centronics, USB, or serial interface, with each communication interface having its own communication protocol.

A CPU bus 811 is a bus for connecting the components of the host computer system 800.

In the printer 812, a CPU 814 controls various input and output signals, and executes programs, such as a printing control process and a communication control process, according to an input instruction. A ROM 815 stores programs for operating the printer 812, such as an input and output control process, a communication control process, a series of operations performed according to an input instruction, such as printing control, and a control command analyzing process, various data, etc. A RAM 816 is used as a work area for the CPU 814 to execute these programs.

An Ethernet® I/F 817 is an interface having a communication protocol for exchanging data between the host computer system 800 and the printer 812. As described above the interface between the host computer system 800 and the printer 812 is not limited to an Ethernet® protocol. As such, the communication protocol used by the printer 812 would be the protocol associated with the particular communication interface being used.

A disk controller I/F 818 has an input and output interface with a disk 813. An engine video I/F 819 for outputting a pattern is an engine control processor having an input and output interface to exchange data and signals with a printer engine 821.

A CPU bus 820 is a bus for connecting the components of the printer 812.

The control processes and operations performed by the document creating and printing application program and printer driver stored in the RAM 806 of the host computer system 800 have been described in the previous section, thus, a description thereof is thus omitted.

The operation of the printer 812 will now be described.

The printing control process in the control program stored in the ROM 815 of the printer 812 is executed to output a document. The details will now be described.

The printer driver on the RAM 806 of the host computer system 800 is operated to transmit a control command for initializing the printer 812. Upon receiving this control command, the printer 812 is initialized.

The printer 812 receives a printer printing control command from the host computer system 800, and analyzes the received printer printing control command and setting parameters to generate bitmap data. The generated bitmap data is transmitted to the printer engine 821 via the engine video I/F 819, and a document is output (printed) (822).

The printer 812 does not necessarily receive a printer control command from the printer driver on the host computer system 800, and may directly receive an HTML document format of a document. Alternatively, the printer 812 may receive the HTML document format and an extension document format including printing control information described with an extension tag or markup directly or via the printer driver, and may interpret the received document format to perform a document printing process.

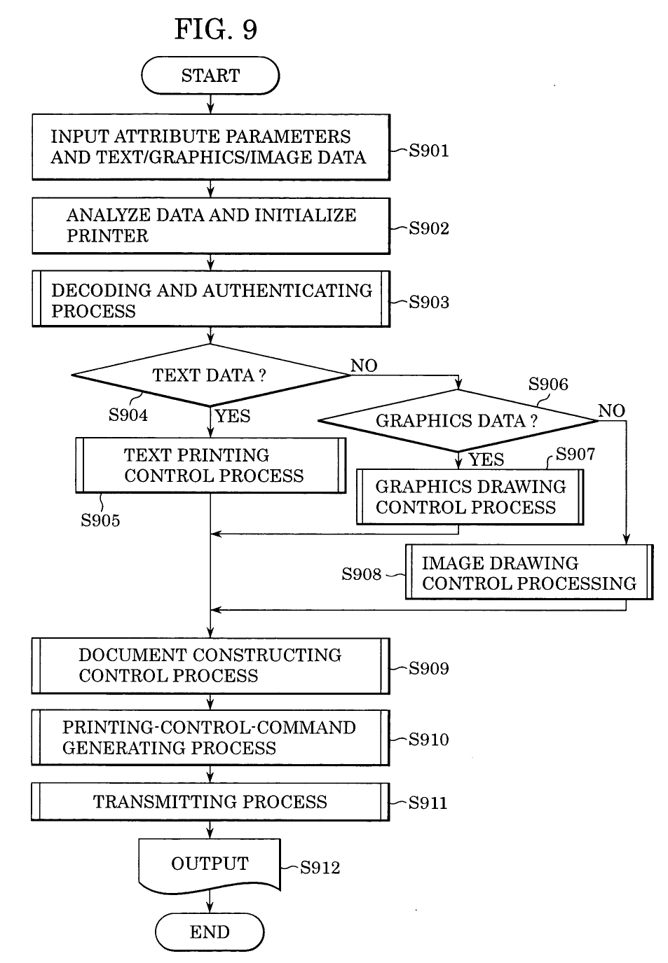

FIG. 9 is a flowchart showing a printing control process of a printer driver on the server 101 and the clients 103, 105, 107, and 109.

The printer driver is a program that is initiated when a printer is instructed to print a document by the document creating and printing application program.

First, in step S901, printing attribute parameters and text, graphics, and image data constituting a document are input.

Next, in step S902, the input parameters and data are analyzed. In order to set the paper size, the printing direction, the graphic resolution, the coordinate units, etc., based on an analysis of the input data, the setting parameters of the printer are converted into a printer control command, and the converted command is transmitted to the printer to initialize the printer.

In step S903, a decoding and authentication process module is performed. In this module, the encrypted authentication information (i.e., the user ID and the password) input by the printout-viewing user is decoded, and is checked against the user authentication information stored in the authentication information database 200 to authenticate the user. When the printout-viewing user is authenticated, a printing control process is performed according to the data type. The parameters and data analyzed in step S902 are separated into text data, graphics data, and image data.

If the text data is selected (YES in step S904), flow proceeds to step S905, where a text printing control process is performed. If the graphics data is selected (NO in step S904 and YES in step S906), then in step S907, a graphics drawing control process is performed. If the image data is selected (NO in step S904 and NO in step S906), then in step S908, an image drawing control process is performed.

After the text printing control process or the graphics or image drawing control process, in step S909, the output format of the document, such as drawing output attributes, the drawing size, and the drawing output position, is determined, and control data for outputting the document is constructed.

Next, in step S910, the control data constructed in step S909 is converted into a printing control command for outputting the document.

In step S911, the printing control command generated in step S910 is transmitted to the printer. Finally, in step S912, the printer prints the document.

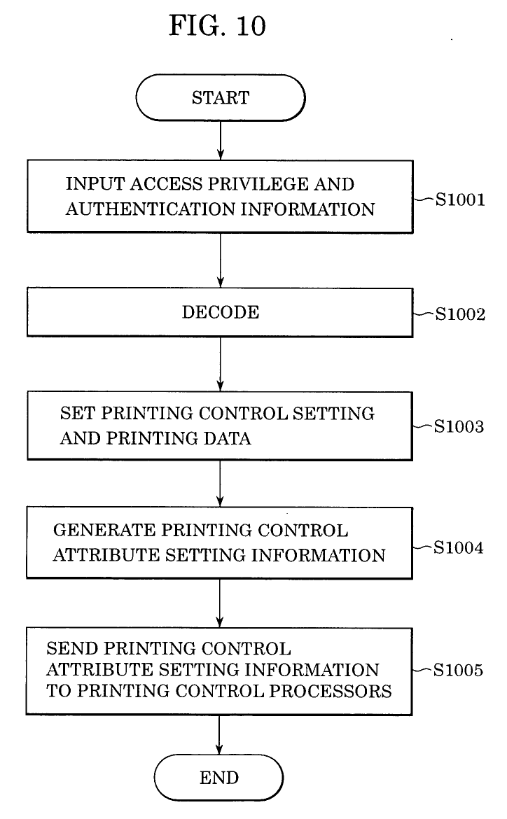

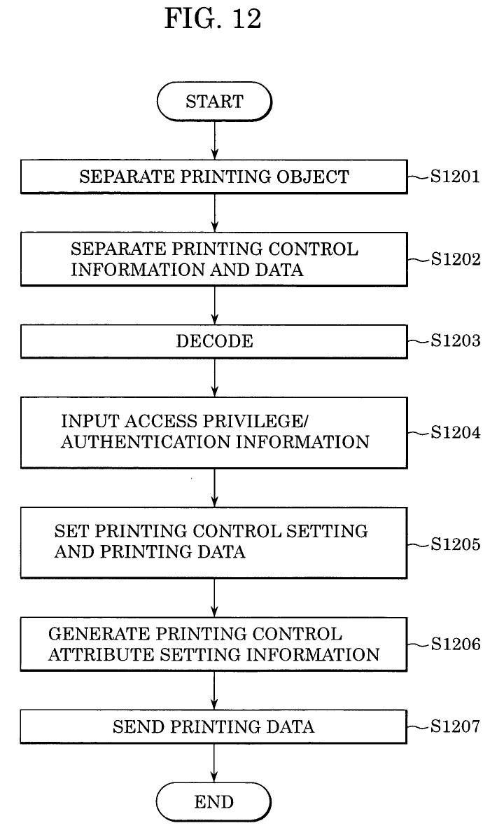

FIG. 10 is a flowchart showing the decoding and authenticating process module in step S903 shown in FIG. 9. In the present embodiment, the decoding and authenticating process module is executed by the printer driver or the printer. The decoding and authenticating process module executed by the printer is described below with reference to FIG. 12.

First, in step S1001, encrypted authentication information (i.e., the user ID and the password) of a printout-viewing user to which the document is to be delivered is input.

In step S1002, the encrypted authentication information is decoded to obtain authentication information.

In step S1003, the obtained authentication information is checked against the user authentication information stored in the authentication information database 200 to authenticate the user. When the printout-viewing user is authenticated, printing control setting and printing data for applying limited viewing of the printed document according to the authentication level, e.g., print-data-modification-based data for overwriting an image to adjust the visible level according to the printing control setting information of a specified region or object and the output format, such as color or monochrome printing, mask printing, high- or low-resolution printing, and mosaic or blur printing, and print data, are prepared. Alternatively, printing control setting and printing data for discarding the printing control setting information of a specified region or object and the printing data for drawing, or for hiding a region or object in a printout by overwriting a rectangular image having the same color as the paper color, such as white, are prepared.

Next, in step S1004, printing control attribute setting information is generated based on the prepared printing control setting and printing data.

Finally, in step S1005, the generated printing control attribute setting information is sent to the printing control processing units.

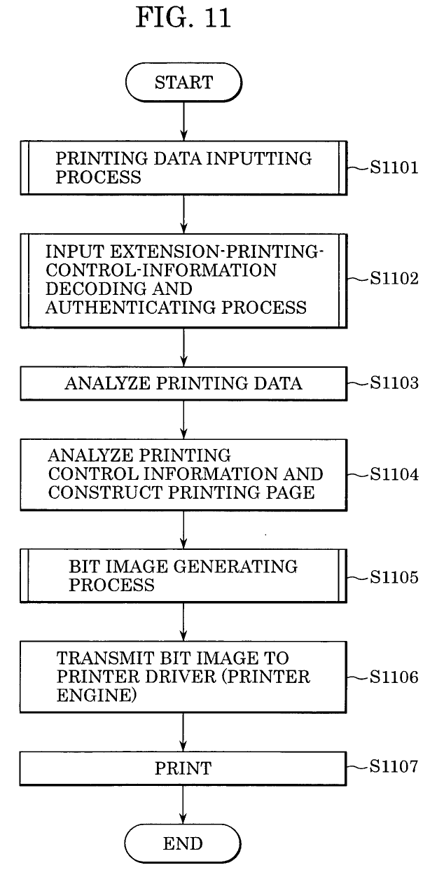

FIG. 11 is a flowchart showing a control process performed by the printer.

In step S1101, printing data including printing control attribute information is received from the printer driver. In this case, a printer control command and printing or drawing data are input. If the printer is capable of interpreting an HTML document format to perform printing control and printing a document, HTML document format data is input directly to the printer.

In step S1102, an input-extension-printing-control-information decoding and authenticating process module is executed. In this module, the encrypted printing control information of the input data that defines the output format for each region or object, such as color or monochrome printing, mask printing, high or low resolution printing, mosaic or blur processing, and printing or non-printing, is decoded according to the encrypted access privilege authentication level of the printout-viewing user to authenticate this user.

In step S1103, the input print data is analyzed.

In step S1104, the printing control information and other printing control information are analyzed to construct the output style of a printing page and a final output image.

In step S1105, a bit image of the printing image is generated based on the constructed final output image, and the generated bit image is loaded in a page memory or a band memory.

In step S1106, the generated bit image is transmitted to the printer engine 821. Finally, in step S1107, the document is printed.

FIG. 12 is a flowchart showing the input-extension-printing-control-information decoding and authenticating process module in step S1102 shown in FIG. 11.

In step S1201, the input printer control command and printing or drawing data, or HTML document format data is interpreted, and a designated printing object is separated.

In step S1202, the printer control command or the printing control information and the output data are also separated.

In step S1203, the printing control information that defines the output format of a specified drawing region or object, and the encrypted authentication information that defines the corresponding privilege are decoded.

In step S1204, access privilege/authentication information for the decoded printing control information is obtained and input.

In step S1205, the authentication level of the input access privilege/authentication information is determined. In this case, the input access privilege/authentication information is checked against the data stored in the authentication information database on the storage device of the external server, or is checked against the data stored in the authentication information database on the storage device of the printer. Then, printing control setting and printing data for applying limited viewing of the printed document according to the determined authentication level, e.g., drawing data according to the printing control setting information of a specified region or object and the output format, such as color or monochrome printing, mask printing, high or low resolution printing, and mosaic or blur processing, are prepared. Alternatively, printing control setting and printing data for discarding the printing control setting information of a specified region or object and the printing data for performing a drawing process, or printing control setting and printing data for drawing a specified rectangular image over a specified region or object in a printout are prepared.

In step S1206, printing control attribute setting information is generated based on the prepared printing control setting and printing data. In step S1207, the printing control attribute setting information and the printing data are sent to the subsequent printing control processing units.

In the present embodiment, therefore, a combination of a Windows® SDK library, which is typically used in a document creating and printing application program in a Windows® operating system environment, and a printer driver SDK library of the present embodiment achieves not only a standard printing function but also printer device functions implemented with an optional device and a printer driver function based on printer device configuration information. Thus, high-value-added printing functionality is provided.

In the application program and the printer driver, moreover, a printer SDK allows a desired function to be automatically used according to the current internal state of the printer device. Thus, a simple user-friendly printing system with high efficiency and high usability is realized.

### Second Embodiment

In the first embodiment, printing control information indicating whether or not printing is performed for each region or object of the document based on the authentication level is added to a document, and the document is delivered to a client that is allowed to view the document. When the client instructs printing of the document, the document is fully or partially printed.

In a second embodiment of the present invention, printing control information associated with a signature or seal image is added to an authorized document, and the document is delivered to a client that is allowed to view the document. When the client instructs printing of the document, the document including a signature or seal image indicating an authorized document is printed.

The basic system configuration and data processing of the present embodiment are the same as those shown in FIGS. 1 and 2 of the first embodiment, thus, a description thereof is omitted. The configuration of the host computer system constituting each printer server and client and the printer, and the printing control process of the printer driver on the server and client according to the present embodiment are the same as those shown in FIGS. 9 and 10 of the first embodiment, thus, a description thereof is omitted.

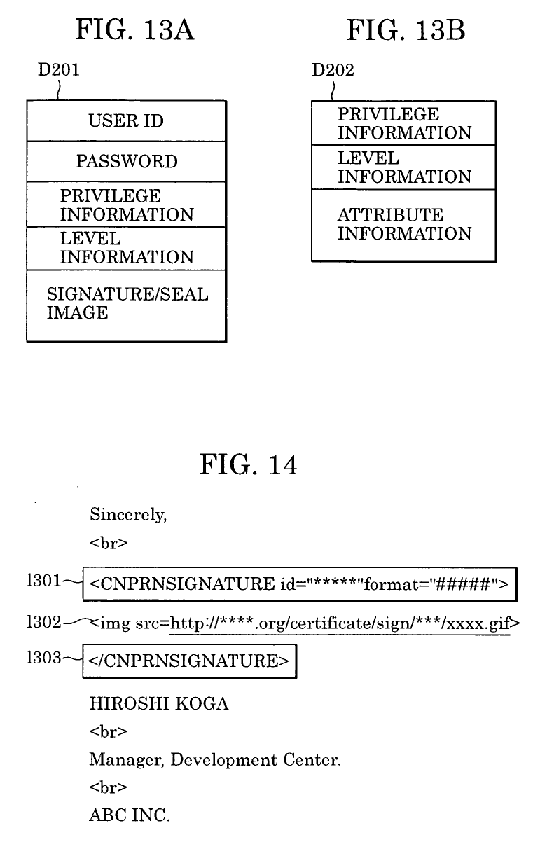

FIGS. 13A and 13B are diagrams showing the data structure of the data stored in the authentication information database 200 according to the present embodiment.

The authentication information database 200 manages authentication information data D201 and privilege level information data D202.

The authentication information data D201 includes an authentication information portion, including a user ID and a password, for identifying a user each time the document is accessed by a plurality of authorizers, a designer, an author, an editor, a distributor, and a viewer of the document, level information including privilege levels for each user and processing levels for each process, and signature or seal image data of a user having authorizer privilege.

A plurality of signature and seal image data of a single authorizer may be stored, and desired image data may be selected.

The signature and seal image data may be separately stored from the authentication information portion and the level information, and may be stored in, for example, a server on the Internet 112 or an intranet. In this case, it is necessary to input a user ID and a password for authenticating an authorizer when the image data is downloaded from the server 100.

The authentication information data D201 corresponding to each member participating in this system is registered and managed in the authentication information database 200.

The privilege information identifies authorizer, designer, author, editor, distributor, and viewer privileges. The level information includes levels indicating access restrictions to each privileged user for this document.

For example, a user allocated level 1 having the editor privilege has privilege to edit the full text of the document, and a user allocated level 2 having the editor privilege has privilege to edit a designated portion of the document. The user allocated level 2 is not allowed to edit and change the overall structure of the document, e.g., table of contents. For example, this user is only allowed to edit a specified chapter in the document.

In another example, users allocated levels having viewer privilege are granted full printing and limited printing privileges of the document.

The privilege level information data D202 is provided for each privilege and level when each of the authorizer, designer, author, editor, distributor, and viewer privileges is further divided by levels, and is constituted by privilege information, level information, and attribute information of the privilege.

The privilege level information data D202 corresponding to each privilege and level employed in this system is registered and managed in the authentication information database 200.

The attribute information indicates access permission and restrictions for each privilege and level, e.g., full or partial editing or full or partial viewing.

FIG. 14 shows an HTML document including tag descriptions 1301, 1302, and 1303 of signature-image output control information and printing control information.

The tag descriptions 1301, 1302, and 1303 are extended, for document printing, in an HTML document format generated using the document creating and editing application program.

In the tag description 1301, a user ID, a password, and a group ID (i.e., identification information of an authorizer) for outputting a signature image are specified by an “id” parameter. Attribute information indicating the control and operation subsequent to the tag description 1301 is specified by a “format” parameter. The tag description 1301 is encrypted and hidden.

In the tag description 1302, a location in which the signature image is stored is specified.

The tag description 1303 indicates the end of the tag description 1301.

The user ID and password specified by the “id” parameter of the extension tag 1301 are checked against the user authentication information to authenticate the authorizer. When the authorizer is authenticated, a “xxxx.gif” file indicating a signature or seal image is read from the storage location on the Internet 112 or an intranet specified in the extension tag 1302, and the signature is printed according to the image format type and output attribute information specified by the “format” parameter in the extension tag 1301.

A procedure for printing the document will now be described in detail.

When an HTML document generated from the application program is to be printed in the application program, for example, in a Windows® operating system environment, an instruction to print and draw the HTML document is typically input from the application program via a GDI (Graphical Device Interface).

In FIG. 14, the character strings prior to and subsequent to the extension tags 1301, 1302, and 1303 indicate that a GDI function is fetched from the output text and printed.

The extension tags 1301, 1302, and 1303 are interpreted by the application program during the printing operation, and the attribute information described with the extension tag 1301 is passed directly to the printer driver using GDI PASSTHROUGH.

The signature image data described with the extension tag 1302 is downloaded in the application program, and is drawn together with the image data using a GDI image drawing function at the defined image output position, size, etc.

The signature outputting process in the application program is terminated by the extension tag description 1303.

This process in the application program may be performed by passing the extension tag descriptions 1301, 1302, and 1303 directly to the printer driver using GDI PASSTHROUGH, and performing the subsequent signature outputting operation in the printer driver.

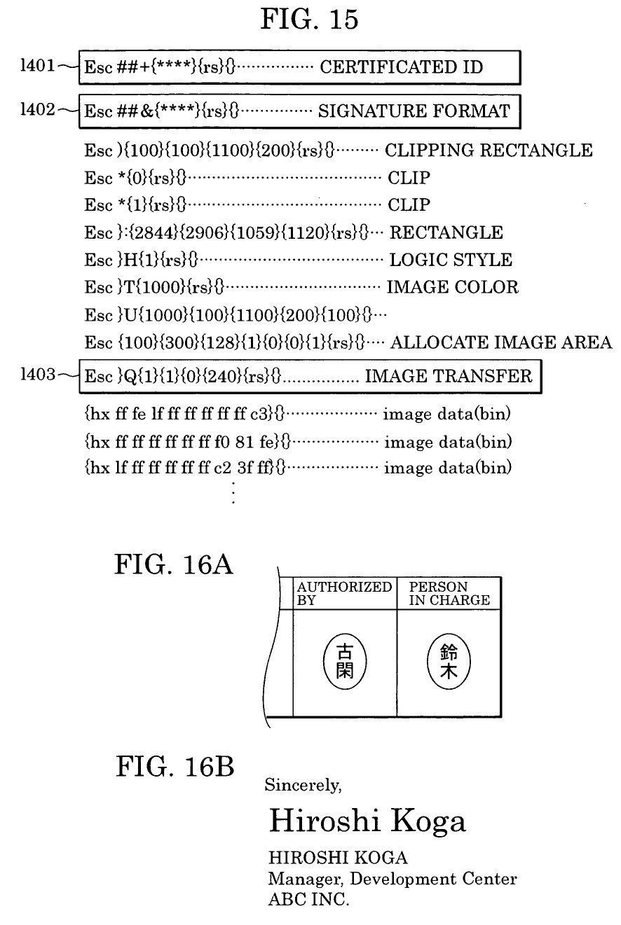

FIG. 15 shows a printer control command generated by the printing control of the printer driver based on the extension tag descriptions 1301, 1302, and 1303 in the HTML document.

Data 1401 is a command parameter including authentication information of a signer, such as a user ID, a password, and a group ID. The ID information portion is encrypted and hidden.

Data 1402 is a command parameter including attribute information indicating the printing format of the signer designated by the data 1401. The attribute information portion is encrypted and hidden.

Data 1403 is a command parameter for drawing a designated signature image in a region of the specified width and height at the specified printing position.

The printer control command specifies how the signature or seal is printed at a specified position in the document. In FIG. 15, a signature image specified by a GIF image file is transmitted to the printer to print the document.

FIG. 16A shows seal images printed at predetermined seal positions, and FIG. 16B shows a signer-name image printed at a predetermined signature printing position. The images shown in FIGS. 16A and 16B are printed based on designation information (i.e., the user ID and password of the authorizer for specifying signature and seal images, and location information of the images) and printing control information (i.e., output format information indicating the output format, such as the image size, the output position, and the color) added to the document data.

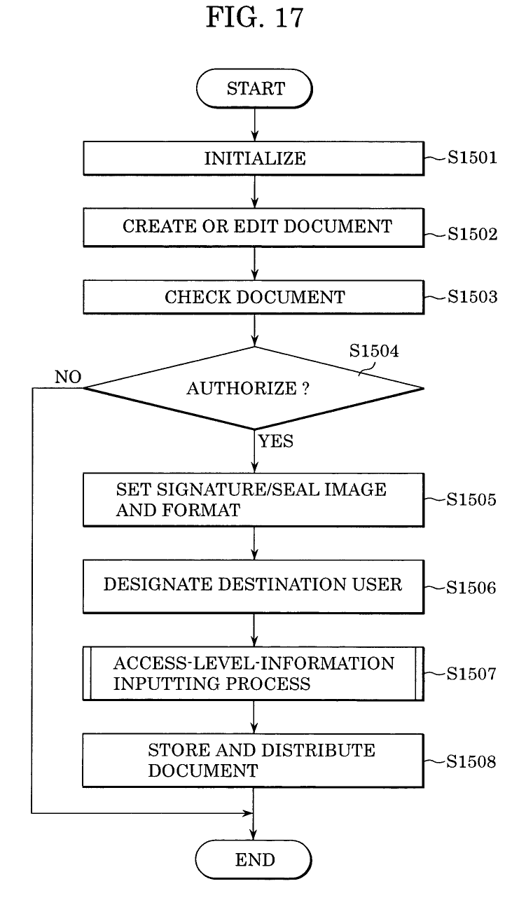

FIG. 17 is a flowchart showing a series of processes for creating and editing a document, specifying a signature image, storing the document, and distributing the document, which is performed by executing a document creating and printing application program according to the present embodiment.

In step S1501, the program is initiated, and attribute values are initialized.

In step S1502, a new document is created or an existing document is edited.

When a new document is created, the document designer and author design and create a document, and determine a qualified authorizer who authorizes the document.

When an existing document is edited, an extension tag description in the document format data of the existing document is checked to determine whether the editor is allowed to edit the existing document, whether a qualified authorizer has been designated, and so on. If the editor is allowed to edit the document, the document is edited. If no qualified authorizer has been designated, a qualified authorizer is designated.

The document designer, author, or editor may be a qualified authorizer of the document.

In step S1503, the qualified authorizer checks the document to be distributed. In step S1504, it is determined whether the qualified authorizer authorizes the document.

If, in step S1504, the document is authorized, flow proceeds to step S1505, where the authorizer inputs a user ID and password for identifying the authorizer, and the input data is checked against the authentication information data D201 and the privilege level information data D202 stored in the authentication information database 200 to authenticate the authorizer. Then, a setting for outputting a signature or seal image unique to the authorizer is performed. If it is determined in step S1504 that the document is not authorized, the process ends.

After setting the signature or seal image in step S1505, flow proceeds to step S1506, where a printout-viewing user to which the document is to be delivered is designated.

This printout-viewing user may be selected from the authentication information data D201 and the privilege level information data D202 stored in the authentication information database 200, or may be selected based on the access-restricted viewing range according to the privilege level of the printout-viewing user.

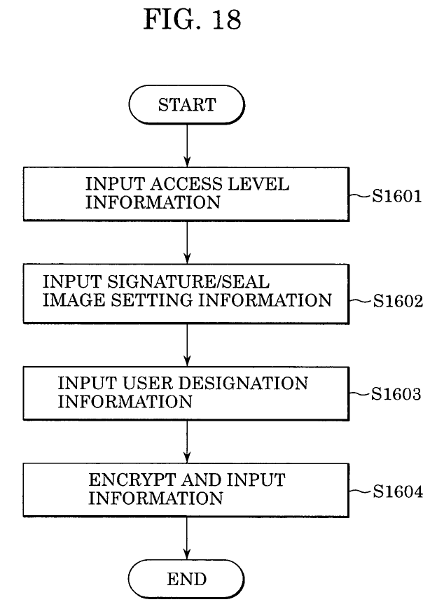

Next, in step S1507, an authentication level information inputting process module is executed. In this module, the authentication information data D201 and the privilege level information data D202 stored in the authentication information database 200 are looked up, and document access level information (e.g., information indicating which access level is allocated to which region of the document) and printing control information indicating the output format of the signature or seal image are described with extension tags or markup. The extension tag or markup descriptions are encrypted and added to the document. The details are described below with reference to FIG. 18.

Finally, in step S1508, the document generated in step S1507 is stored in the document database 201, and the document is distributed.

FIG. 18 is a flowchart showing the details of the authentication level information inputting process module in step S1507 shown in FIG. 17.

In step S1601, a region of a document that may be accessed (viewed) by a user to which the document is to be delivered (i.e., a printout-viewing user) is specified for each access level in the privilege level information stored in the authentication information database 200.

In step S1602, a document authorizer inputs a user ID and password for identifying this authorizer, and the input data is checked against the authentication information data D201 and the privilege level information data D202 stored in the authentication information database 200 to authenticate the authorizer. Then, a signature or seal image unique to the authorizer is selected, and information indicating output settings of the image, such as the image size, the output position, and the color, is specified and input.

In step S1603, a user ID, a password, a group ID, etc., required for authenticating the user to which the document is to be delivered (or the printout-viewing user) are input.

In step S1604, the input authentication information is described with an extension tag or markup, and the extension tag or markup description is encrypted and added to the document.

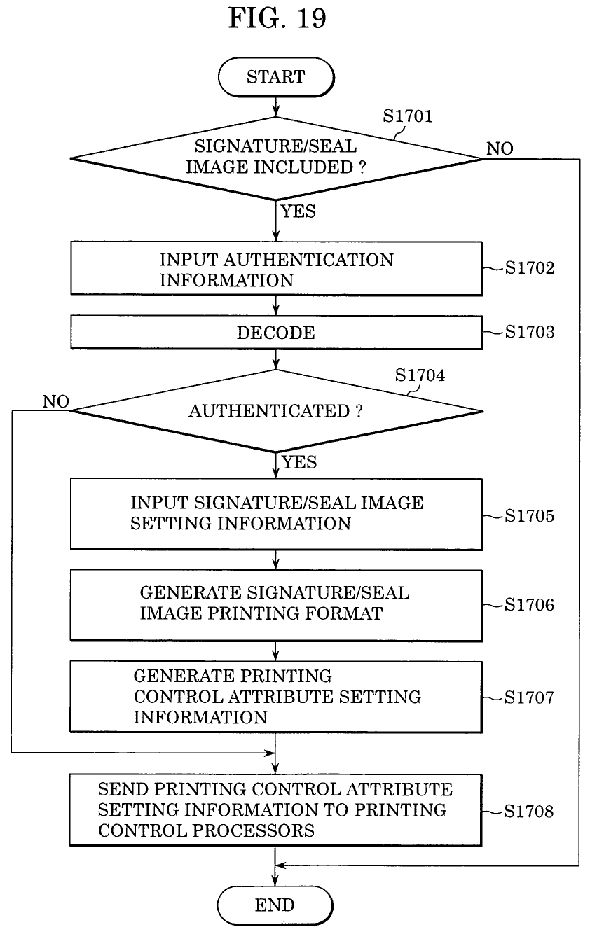

FIG. 19 is a flowchart showing the details of the decoding and authenticating process module in step S903 shown in FIG. 9 according to the present embodiment.

In step S1701, it is determined whether the document includes a signature or seal image. If the document does not include a signature or seal image, the process ends.

If the document includes a signature or seal image, flow proceeds to step S1702, where encrypted authentication information (i.e., a user ID and a password) of a printout-viewing user to which the document is to be delivered is input.

Then, in step S1703, the encrypted authentication information is decoded to obtain the authentication information.

Next, in step S1704, the obtained authentication information is checked against the authentication information data D201 and the privilege level information data D202 of the printout-viewing user stored in the authentication information database 200 to authenticate the user. If the printout-viewing user is authenticated, flow proceeds to step S1705, where a signature or seal image of the document author or editor, and information that sets the output format of the image are input. If the printout-viewing user is not authenticated, the process proceeds to step S1708.

The image may be fetched from the authentication information data D201 stored in the authentication information database 200, or may be downloaded from a server on the Internet 112 or an intranet.

Following the input of signature or seal image and setting information in step S1705, flow proceeds to step S1706, where the output format of the input signature or seal image is generated. Then, in step S1707, printing control attribute setting information for printing of the signature or seal image is generated.

In step S1708, the generated printing control attribute setting information is sent to the printing control processing units. If the authentication fails in step S1704, then the authentication failure is sent to the printing control processing units.

The control process performed by the printer according to the present embodiment is the same as that of the first embodiment, except for the processing of step S1102 shown in FIG. 11.

In the present embodiment, in step S1102, a signature-image-setting-information/accessing-user-designation-information decoding and authentication process module is executed. In this module, encrypted information of the input data, namely, authentication information of a printout-viewing user and printing control information that specifies the output format of a signature or seal image, is decoded to perform authentication.

Therefore, according to the present embodiment, higher-efficiency authorization of printed documents is realized than standard authorization by signing or affixing a seal on printouts such as paper media.

Moreover, digital data of authorized documents is distributed over a network. Thus, the distribution and transportation cost can be reduced compared to traditional paper-based distribution and circulation.

As described above, in place of an HTML document, an XML, XHTML, SGML, or MHEG document, which is a structured document having a hierarchical data structure and having a plurality of classified elements, may be used. The features of these document formats can be utilized, thus achieving general-purpose high-usability system construction and operation.

As described above, in place of an HTML document, a new dedicated document format, which is a semi-structured document having a hierarchical data structure and having a plurality of classified elements, may be used. A printing device and a printer driver dedicated to this document format implement this system, thus realizing simple low-cost system construction and operation.

### Third Embodiment

In the first embodiment, by executing a document creating and printing application program, a document is created and edited, and an HTML document is generated. In a third embodiment of the present invention, in place of an HTML document, an XML, XHTML, SGML, or MHEG document, which is a structured document having a hierarchical data structure and having a plurality of classified elements, is employed to implement a data processing method and apparatus of the third embodiment.

According to the present embodiment, a variety of document formats can be handled, and the features of these document formats can be utilized, thus achieving general-purpose high-usability system construction and operation.

### Fourth Embodiment

In the first embodiment, by executing a document creating and printing application program, a document is created and edited, and an HTML document is generated. In a fourth embodiment of the present invention, in place of an HTML document, a dedicated new document format, which is a semi-structured document having a hierarchical data structure and having a plurality of classified elements, is employed to implement a data processing method and apparatus of the fourth embodiment.

According to the present embodiment, a dedicated document format is used, and a printing device and a printer driver dedicated to this document format implement this system, thus realizing low-cost easy system construction and operation.

### Fifth Embodiment

In a fifth embodiment of the present invention, a tag and markup description of printing control information, which is generated using a document creating and printing application program, is specified by a printer driver, and is added in a control process performed by the printer driver.

In the application program, allocation of an identifier, a user ID, a password, a group ID, etc., for identifying a printout-viewing user is performed on a user interface of the printer driver. This allocation and the printing control information that is added by the control process of the printer driver are described with tags and markup. The tag and markup descriptions are added. This implements a data processing method and apparatus of the present embodiment.

### Sixth Embodiment

The structure of a sixth embodiment of the present invention is basically the same as that of the second embodiment.

In the present embodiment, printing control information indicating the output format of a signature or seal image is described with a tag and markup using a printer driver, and the tag and markup description is added to an HTML document format in the control process performed by the printer driver.

Moreover, allocation of an identifier, a user ID, a password, a group ID, etc., for identifying a printout-viewing user is performed on a user interface of the printer driver. This allocation and printing control information that indicates the output format of a signature or seal image are described with tags and markup, and the tag and markup descriptions are added in a control process performed by the printer driver.

### Seventh Embodiment

The structure of a seventh embodiment of the present invention is basically the same as that of the second embodiment.

In the present embodiment, authentication information that identifies a printout-viewing user is decoded by a processing program of a printing device, and the printing device prints a document.

A printing device serving as a final printing unit performs decoding, thus providing higher security.

### Other Embodiments

In a further embodiment of the present invention, a storage medium that stores program code (i.e., computer-executable process steps) of software implementing the functions of the illustrated embodiments is supplied to a system or an apparatus. The functions of the illustrated embodiment may be achieved by reading the program code stored in the storage medium and executing the read program code by a computer (or a CPU or an MPU) of the system or apparatus.

In this case, the program code read from the storage medium constitutes a new function of this embodiment, and the storage medium that stores the program code constitutes this embodiment.

Storage media for storing the program code include, but are not limited to, a floppy disk, a hard disk, a magneto-optical disk, an optical disk, a CD-ROM, a CD-R, a magnetic tape, a non-volatile memory card, a ROM, etc.

The program code read by the computer is executed, thereby achieving the functions of this embodiment. The entirety of or a portion of the actual processing is performed by an operating system running on the computer according to an instruction of the program code, thereby achieving the functions of the illustrated embodiments.

The program code read from the storage medium is written to a memory of a function expansion board inserted in the computer or a function expansion unit connected to the computer, and a CPU or the like of the function expansion board or the function expansion unit executes the entirety of or a portion of the actual processing according to an instruction of the program code, thereby achieving the functions of the illustrated embodiments.

This embodiment is also applicable to a case in which a storage medium stores program code of software implementing the functions of the illustrated embodiments and the program is distributed from the storage medium to a requester via a communication line, such as a personal computer communication network.

While the present invention has been described with reference to what are presently considered to be the embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Applications No. 2003-434542 filed Dec. 26, 2003 and No. 2003-406087 filed Dec. 4, 2003, which are hereby incorporated by reference herein.

1. In a network-based printing system having a communication network, a data processing method comprising:
an adding step of adding printing control information to document data or image data;
a transmitting step of transmitting the data generated in the adding step to a user designated by an access privilege level that is stored in a server; and
a controlling step of controlling printing of the data transmitted in the transmitting step according to authentication information input by the user and the printing control information added in the adding step.

2. In a network-based printing system having a communication network, a data processing method comprising:
an adding step of adding printing control information to document data or image data; and
a transmitting step of transmitting the data generated in the adding step to a user designated by an access privilege level that is stored in a server.

3. In a network-based printing system having a communication network, a data processing method comprising:
a controlling step of receiving data including printing control information, and controlling printing of the received data according to authentication information that is input by a user and the printing control information included in the data.

4. Computer-executable process steps for causing a computer to execute a document printing method for a document printing system having a client device and a printing device, the client device and the printing device being connected via a communication network, the computer-executable process steps comprising:
an adding step of adding printing control information to document data and transmitting the document data, the printing control information including limitation information that limits printing of a document and instruction information that instructs printing of a predetermined image, wherein the adding step is performed by the client device; and
a printing step of, based on the document data and the printing control information transmitted in the adding step, printing the document data according to the limitation information and printing the predetermined image, wherein the printing step is performed by the printing device.

5. The data processing method according to claim 2, wherein the printing control information is added using an extension tag or markup.

6. The data processing method according to claim 2, wherein the printing control information is added to an object or a block including a plurality of objects.

7. The data processing method according to claim 2, wherein the printing control information is added depending upon the access privilege level stored in the server.

8. The data processing method according to claim 3, wherein the controlling step is performed by a printing device.

9. The data processing method according to claim 3, wherein a printing device or a printer driver sets and instructs a printing function based on the data including the printing control information, wherein the printing device prints a document based on the instructed printing function.

10. The data processing method according to claim 3, wherein the controlling step performs color or monochrome printing, mask printing, high or low resolution printing, or mosaic or blur processing for an entire document or in units of pages, blocks, paragraphs, sentences, or words.

11. In a network-based printing system having a communication network, a data processing apparatus comprising:
adding means for adding printing control information to document data or image data; and
transmitting means for transmitting the data generated by the adding means to a user designated by an access privilege level that is stored in a server.

12. In a network-based printing system having a communication network, a data processing apparatus comprising:
controlling means for receiving data including printing control information, and controlling printing of the received data according to authentication information that is input by a user and the printing control information included in the data.

13. Computer-executable process steps for causing a computer to execute the data processing method according to claim 2.

14. A document printing system including a client device and a printing device connected via a communication network, wherein the client device includes adding means for adding printing control information to document data and transmitting the document data, the printing control information including limitation information that limits printing of a document and instruction information that instructs printing of a predetermined image, and
wherein the printing device includes printing means for, based on the document data and the printing control information transmitted by the adding means, printing the document data according to the limitation information and printing the predetermined image.

15. The system according to claim 14, further comprising:
a first database that stores limitation level information that limits printing of the document, the limitation level information being set on a user-by-user basis; and
a second database that stores image data indicating authorization of the document, the image data being set on a document authorizer-by-document authorizer basis,
wherein the adding means generates the printing control information by looking up the first and second databases, and adds the printing control information to the document data.

16. The system according to claim 14, further comprising:
a first database that stores limitation level information that limits printing of the document, the limitation level information being set on a user-by-user basis; and
a second database that stores image data indicating authorization of the document, the image data being set on a document authorizer-by-document authorizer basis,
wherein the printing means prints the document data according to the limitation information by looking up the first database, and prints an image indicated by the instruction information by looking up the second database.

17. The system according to claim 14, wherein the client device or a server connected to the communication network includes a printer driver,
wherein the printer driver generates printing function setting information based on the printing control information, and transmits the generated printing function setting information to the printing means, and
wherein the printing means prints the document data and the image based on the printing function setting information.

18. The system according to claim 14, wherein the adding means transmits the document data including the printing control information to a client device of a user to which the document is to be delivered,
wherein the client device of the user to which the document is to be delivered determines whether the user to which the document is to be delivered has access privilege of the document data,
wherein, when the user to which the document is to be delivered has access privilege, the client device generates printing function setting information based on the printing control information, and transmits the printing function setting information to the printing means, and
wherein the printing means prints the document data and the predetermined image based on the printing function setting information.

19. The system according to claim 14, wherein the document data has a structured document format having a hierarchical structure and having a plurality of classified elements, and
wherein the adding means adds the printing control information to the document format using an extension tag or markup.

20. The system according to claim 19, wherein the adding means includes encrypting means for encrypting the printing control information added to the document format using the extension tag or markup.

21. The system according to claim 19, wherein the document format comprises any one of HTML, SGML, XML, MHEG, HTML, and XHTML document formats.

22. The system according to claim 14, further comprising:
a third database that stores access level information indicating a plurality of different levels for accessing the document data, the access level information being set according to a user attribute;
a fourth database that stores an identification code unique to each user for identifying the user; and
controlling means for authenticating a user who operates the client device by looking up the fourth database, and operating the adding means when the user is authenticated,
wherein the adding means reads the access level information corresponding to the user by looking up the third database, generates printing control information based on the access level information, and adds the generated printing control information to the document data.

23. A client device connected to a printing device via a communication network, comprising:
generating means for generating printing control information including limitation information that limits printing of a document and instruction information that instructs printing of a predetermined image;
adding means for adding the printing control information generated by the generation means to document data; and
transmitting means for transmitting the document data to the printing device to cause the printing device to print the document based on the document data and the printing control information.

24. A printing device connected to a client device via a communication network, comprising:
receiving means for receiving document data from the client device, the document data including printing control information including limitation information that limits printing of a document and instruction information that instructs printing of a predetermined image; and
printing means for, based on the document data and the printing control information received by the receiving means, printing the document data according to the limitation information and printing the predetermined image.

25. A document printing method for a document printing system including a client device and a printing device, the client device and the printing device connected via a communication network, the method comprising:
an adding step of adding printing control information to document data and transmitting the document data, the printing control information including limitation information that limits printing of a document and instruction information that instructs printing of a predetermined image, wherein the adding step is performed by the client device; and
a printing step of, based on the document data and the printing control information transmitted in the adding step, printing the document data according to the limitation information and printing the predetermined image, wherein the printing step is performed by the printing device.

26. The method according to claim 25, wherein the document printing system includes:
a first database that stores limitation level information that limits printing of the document, the limitation level information being set on a user-by-user basis; and
a second database that stores image data indicating authorization of the document, the image data being set on a document authorizer-by-document authorizer basis; and
wherein the adding step generates the printing control information by looking up the first and second databases and adds the printing control information to the document data.

27. The method according to claim 25, wherein the document printing system includes:
a first database that stores limitation level information that limits printing of the document, the limitation level information being set on a user-by-user basis; and
a second database that stores image data indicating authorization of the document, the image data being set on a document authorizer-by-document authorizer basis; and
wherein the printing step prints the document data according to the limitation information by looking up the first database, and prints an image indicated by the instruction information by looking up the second database.

28. The method according to claim 25, wherein the client device or a server connected to the communication network includes a printer driver,
wherein the printer driver generates printing function setting information based on the printing control information, and transmits the generated printing function setting information to the printing device, and
wherein the printing step prints the document data and the image based on the printing function setting information.

29. The method according to claim 25, wherein the adding step transmits the document data including the printing control information to a client device of a user to which the document is to be delivered,
wherein the client device of the user to which the document is to be delivered determines whether the user to which the document is to be delivered has access privilege of the document data,
wherein when the user to which the document is to be delivered has access privilege, the client device generates printing function setting information based on the printing control information, and transmits the printing function setting information to the printing device, and
wherein the printing step prints the document data and the predetermined image based on the printing function setting information.

30. The method according to claim 25, wherein the document data has a structured document format having a hierarchical structure and having a plurality of classified elements, and
wherein the adding step adds the printing control information to the document format using an extension tag or markup.

31. The method according to claim 30, wherein the adding step includes an encrypting substep of encrypting the printing control information added to the document format using the extension tag or markup.

32. The method according to claim 30, wherein the document format comprises any one of HTML, SGML, XML, MHEG, HTML, and XHTML document formats.

33. The method according to claim 25, wherein the document printing system further includes:
a third database that stores access level information indicating a plurality of different levels for accessing the document data, the access level information being set according to a user attribute; and
a fourth database that stores an identification code unique to each user for identifying the user,
wherein the document printing method further comprises a controlling step of authenticating a user who operates the client device by looking up the fourth database, and performing the adding step when the user is authenticated, and
wherein the adding step reads the access level information corresponding to the user by looking up the third database, generates printing control information based on the access level information, and adds the generated printing control information to the document data.
